(19) United States
(12) Patent Application Publication
(10) Pub. No.: US 2007/0194258 A1
(43) Pub. Date: Aug. 23, 2007

(54) Web Breakage Monitoring Device For Web-Fed Rotary Printing Presses

(75) Inventor: Bernhard Brandmeier, Kissing (DE)

Correspondence Address: MORGAN & FINNEGAN, L.L.P., 3 WORLD FINANCIAL CENTER, NEW YORK, NY, 10281-2101, US

(73) Assignee: BALDWIN GERMANY GMBH, Augsburg (DE)

(21) Appl. No.: 11/466,957

(22) Filed: Aug. 24, 2006

(30) Foreign Application Priority Data
Sep. 3, 2005 (DE) 10 2005 041 919.4

(51) Int. Cl. G01N 21/85

(52) U.S. Cl. 250/573

(57) ABSTRACT

Web breakage monitoring device for web-fed rotary printing presses; containing a detection device (26) for detecting a longitudinal web edge strip (22, 24) of a printable web (8) and a pneumatic deflection device (30) with at least one compressed-air nozzle (32, 34) for generating a pneumatic deflection force at right angles to the web plane on the longitudinal web edge strip adjacent to the detection device; a control device (50) that changes the pneumatic deflection force as a factor of the web velocity of the printable web (8).

### CROSS-REFERENCE TO RELATED APPLICATIONS

This application claims priority under 35 USC 119 of German application No. DE 10 2005 041 919.4, filed on Sep. 3, 2005.

### FIELD OF THE INVENTION

The invention relates to a web breakage monitoring device for web-fed rotary printing presses according to the introductory clause of claim 1.

### BACKGROUND

A web breakage monitoring device of this type for web-fed rotary printing presses is known from DE 39 39 226 A1. It can be located in the printing press at any suitable location. It is preferably located between the last printing couple of the printing press and a dryer for drying the printable web, because web breakage develops most frequently in the dryer.

A device for detecting web defects before the first printing couple of a web-fed rotary printing press is known from EP 0 895 860 B1. It contains sensors that contain a plurality of optical fibers and generate a signal dependent upon the shading of the optical fiber beams by the printable web.

The object of the invention is to increase operational reliability in a web breakage monitoring device of the type mentioned initially.

### SUMMARY OF THE INVENTION

The object is attained according to the invention by the features of claim 1.

At high web speeds, tensile stress increases in the printable web. In printing presses of the prior art, this leads to a delayed deflection of the printable web by the pneumatic deflection device in the event of web breakage. During this delay, the printing press continues to operate and a large length of printable web passes through the printing press. This length of printable web is waste. When the torn-off printable web is wrapped onto a printing press cylinder, the large number of wrapped printable web layers can become jammed in a cylinder gap. This can cause machine parts to break. However, if the deflection pressure of the deflection device is set to a higher value to achieve faster deflection of the fast-moving printable web, in printing presses of the prior art the risk arises that the printable web, at low web speed, particularly during startup of the printing press, when the printable web has a lower tensile stress than at a higher web speed, is pressed away from the deflection device and out of the measuring range of the web breakage monitoring device, thereby incorrectly triggering a web breakage signal even though there is no web breakage. Both disadvantages are avoided by the invention. As a result of the invention, greater operational reliability of the web breakage monitoring device and greater operating safety of the web-fed rotary printing press is achieved.

Additional features of the invention are included in the subsidiary claims. The monitoring device also generates a web breakage signal when web tension declines for a reason other than web breakage such that a longitudinal strip of the edge of the web drops out of the detection range of the detection device. For this reason, the monitoring device can be used more generally, irrespective of web breakage, to monitor the tensile stress of the printable web.

In the following, the invention is described, with reference to the figures, on the basis of preferred embodiments serving as examples. The figures show the following:

### BRIEF DESCRIPTION OF THE DRAWINGS

FIG. 1 a schematic side view of a web breakage monitoring device, according to the invention, in a web-fed rotary printing press, the latter being depicted only in part and schematically,

FIG. 2 a schematic top view of the web breakage monitoring device and the web-fed rotary printing press from FIG. 1,

FIG. 3 a schematic front view along the plane III-III from FIG. 2, with only the printable web and parts of the web breakage monitoring device being shown,

FIG. 4 a depiction, similar to FIG. 3, of a further embodiment of a web breakage monitoring device according to the invention.

### DETAILED DESCRIPTION

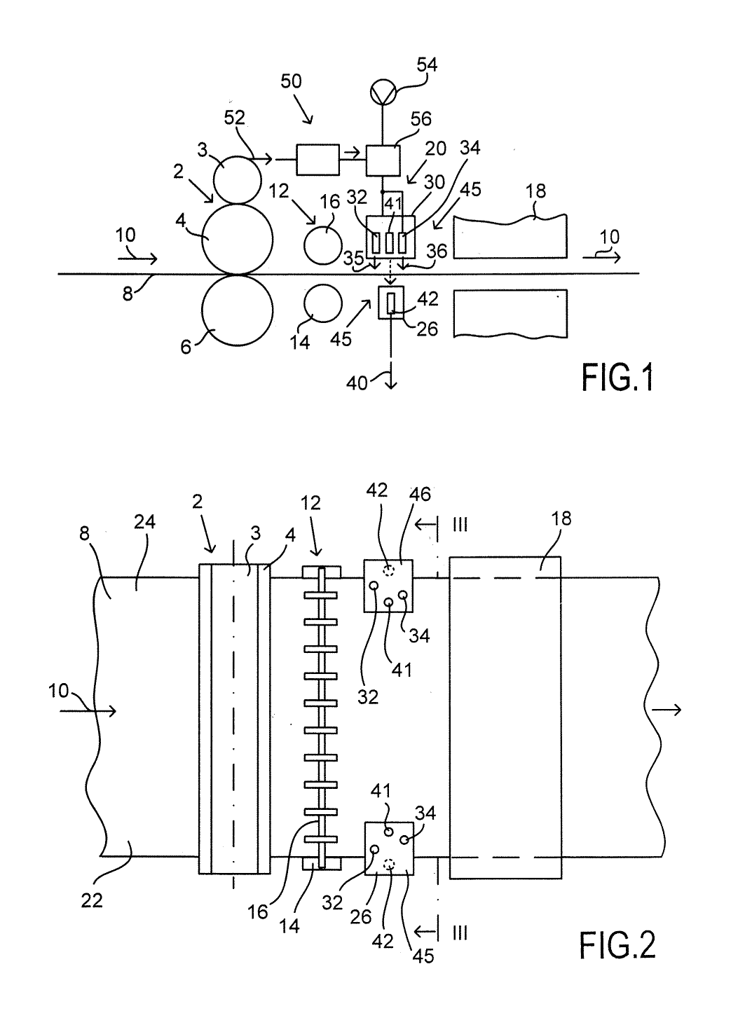

The section of a web-fed rotary printing press depicted schematically in FIG. 1 shows parts of the last printing couple of a plurality of printing couples. As an example, a plate cylinder 3, an upper rubber blanket cylinder 4 and a lower rubber blanket cylinder 6 of an offset web-fed rotary printing press are shown, between which the printable web 8 runs during printing operation in the web movement direction 10. A web-fed rotary printing press can contain one or a plurality of printing couples 2.

A web catcher 12 is depicted schematically downstream of the last printing couple 2. It can take any form and, in the case of web breakage, clamps the section of the printable web 8 following the breakage point and deflects it from the printing press. The web catcher 12 can contain, for example, a catching drum 14 and a contact drum 16 (Trolly drum). In the case of trouble-free printing press operation, the printable web 8 runs through the two drums 14 and 16 without being clamped. In the case of web breakage, the web is clamped between the two drums 14, 16 and deflected downward.

During normal operation, after passing through the catcher 12 the printable web 8 runs through a dryer 18 for drying the printing ink.

A web breakage monitoring device 20 according to the invention contains at least one detection device 26 for at least one longitudinal web strip 22 or 24, preferably for both longitudinal web strips 22 and 24 of the printable web 8, said detection devices being oriented at right angles to the web plane and toward the applicable longitudinal web strip 22 or 24 of the printable web 8, for detecting of the longitudinal web edge strip of the printable web 8, which is under tensile stress during normal printing operation, and for generating a web breakage signal if the longitudinal web edge strip 22, 24 drops out of the detection range of the detection device 26 when the tensile stress of the printable web decreases as a result of web breakage.

The web breakage monitoring device 20 also contains, for at least one, preferably for both longitudinal web edge strips 22 and 24, a pneumatic deflection device 30 located in proximity to the detection device 26. The deflection device 30 contains at least one or, according to the preferred embodiment shown in the drawings, two compressed-air nozzles 32 or 34 in proximity to the detection device 26 of the applicable longitudinal web edge strip 22 or 24 directed, at right angles to the web plane, at the longitudinal web edge strip 22 or 24, whose compressed-air jets 35 or 36 generate a permanent pneumatic deflection force acting on the longitudinal web edge strip 22 or 24 at right angles to the web plane and surmountable by the tensile force of the printable web during trouble-free operation. The compressed-air jets 35 and 36, as well as their deflection forces, are schematically depicted by arrows in FIGS. 1,3 and 4. As a result of these pneumatic deflection forces, when its tensile stress falls below a predetermined value the printable web 8 is deflected at right angles to the web plane, preferably downward, and thus moves out of the detection range of the detection device 26.

The elements of the detection device 26 and the deflection device 30 acting on the printable web 8 can be located anywhere within the printing press, and are preferably located where breakage (tearing off) of the printable web 8 occurs most frequently.

Normally, breakage in the printable web 8 occurs most frequently in the dryer 18. For this reason, the elements of the detection device 26 and the deflection device 30 are preferably located between the last printing couple and the dryer 18, especially preferably between the catcher 12 and the dryer 18, as shown in FIG. 1. These elements can be attached to a non-rotating part of the web catcher 12 or to the dryer 18 or, separately, to a fixed element of the printing press.

In the event of web breakage, the tensile stress of the printable web 8 declines to such an extent that the printable web 8 is moved out of the detection range of the detection device 26 by the permanently generated pneumatic deflection force of compressed-air jets 35 and 36. As soon as the detection device 26 no longer finds the longitudinal web edge strip 22 or 24 in the detection range, it generates a web breakage signal (e.g., an electric or pneumatic or hydraulic signal), which is depicted schematically in FIG. I by an arrow 40. As a result of the web breakage signal 40, the printing press is switched off automatically and the web catcher 12 is activated.

Several embodiments are possible. According to one embodiment, the web breakage signal 40 has a value of zero during printing operation without web breakage and, if web breakage occurs, it is automatically switched to a value other than zero, e.g., a positive or negative electric signal value. Another embodiment can consist in the detection device 26 constantly generating a signal during defect-free, normal printing operation, said signal being automatically switched off when web breakage is detected, so that the switched-off signal (signal value of zero) is the web breakage signal 40. According to yet another embodiment, a signal diverging from the value zero is generated constantly, said signal being different during web breakage-free printing operation than when web breakage is detected. To simplify the description of the invention, it is described and claimed that the web breakage signal 40 is switched on when web breakage is detected as a result of a drop in the tensile stress of the printable web 8; this applies to all embodiments described.

In the event of web breakage, the printable web 8 would also drop out of the detection range of the detection device 26 without the pneumatic deflection force of the compressed-air jets 35 and 36 from the compressed-air nozzles 32 and 34, but only much later than when reinforced by the pneumatic deflection force.

According to the preferred embodiment of the invention, one compressed-air nozzle 32 is located upstream of the detection device 26, as seen in the web movement direction 10, and another compressed-air nozzle 34 is located downstream of the detection device 26.

The detection device 26 can be executed in various forms, e.g., as a pneumatic or electric proximity switch that generates a defined signal as a factor of the distance from the printable web 8 or as a factor of whether or not the printable web 8 is located within its sensor range. According to another embodiment, the detection device 26 can include a reflex light barrier that has a light transmitter and a light receiver on the same web side.

The detection device 26 preferably contains a transmitter 41 on one web side and a receiver 42 on the corresponding other web side for transmitting a detection beam 43 along a straight detection axis 44 that intersects the range of the longitudinal web edge strip 22 or 24 and, as a result, is only interrupted by the printable web 8 if it is under tensile stress. The transmitter 41 and the receiver 42 preferably form a light barrier, preferably an infrared light barrier whose light beam is the detection beam 43.

The transmitter 41 (or the receiver 42) is, in the web movement direction 10, preferably located between the two compressed-air nozzles 32 and 34 and/or, in the direction at right angles to the web, offset relative to the compressed-air nozzles 32 and 34. On each web side, one such transmitter 41, one such receiver 42 and the two compressed-air nozzles 32 and 34 (or only one compressed-air nozzle 32 or 34) can be combined to form one monitoring unit 45 or 46.

According to the invention, a control device 50 is provided that reacts to a web velocity signal 52 that changes with changing web velocity of the printable web 8 and, as a factor thereof, reduces the pneumatic deflection force of the compressed-air jets 36 acting on the printable web 8 to a predetermined degree with decreasing web velocity and increases it with increasing web velocity. The pneumatic deflection force preferably has a predetermined strength at a predetermined web velocity. The deflection force can be modifiable proportionally, over-proportionally or under-proportionally, or in a different manner as a factor of the web velocity, which in turn can be dependent upon the type of printing press and/or the material of the printable web 8.

According to the invention, at a high web velocity of the printable web 8 in the web movement direction 10, the pneumatic deflection force of the compressed-air jets 35 and 36 is set to a substantially higher value than at a lower web velocity, without the printable web 8 being pushed out of the range of the detection beams 43 of the detection device 26. According to the advantage of the invention, this results in the high pneumatic deflection force of the compressed-air jets 35 and 36 acting at high web velocity so that if there is web breakage the printable web 8 can be quickly pushed out of the detection range of the detection beam 43. As a result of the strength of the pneumatic deflection force being a factor of web velocity, according to the invention the deflection force is automatically reduced at lower web velocity such that the deflection force cannot push the breakage-free printable web 8 out of the detection beam 43 of the detection device 26. In both cases, however, very rapid deflection of the printable web 8 out of the detection beam 43 of the detection device 26 is achieved in the event of web breakage.

The change in the strength of the pneumatic deflection force preferably occurs by means of a corresponding change in the pressure of the compressed air being supplied to the nozzles 32, 34 by a compressed-air source 54 through a pressure adjustment element 56, e.g., a pressure regulator or a pressure control valve. An additional or alternative embodiment option is comprised in that the jet direction of the compressed-air nozzles 32 and 34 is modified relative to the printable web 8 in order to change the pneumatic deflection force acting on the printable web. The pressure adjustment element 56 and the jet direction of the compressed-air nozzles 32, 34 are automatically controlled by the control device 50.

The control device 50 preferably receives the electric (or pneumatic) web velocity signal 52, the strength of which is dependent upon the web velocity of the printable web 8, from a printing press control device. The printing press control device normally generates, for other functions of the printing press, a web velocity signal dependent upon the web velocity. The web velocity signal 52 could also be generated by a signal transmitter activated by a cylinder, a drum or a roll that rotates or rotate with the velocity of the printable web 8.

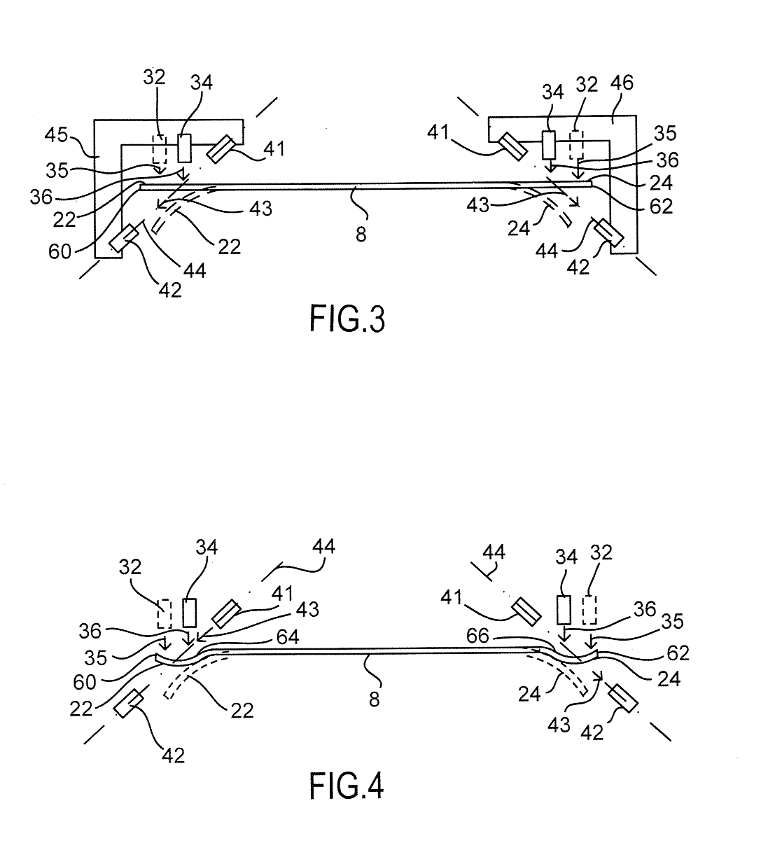

The detection axis 44 between transmitter 41 and receiver 42 is preferably disposed at an angle to the web plane of the printable web 8 as shown in FIGS. 3 and 4, so that one of the two interacting parts, the transmitter 41 or the receiver 42 of the detection axis 44, is farther away from the latitudinal center of the web than the other part. Preferably the one part, which is the receiver 42, for example, is located laterally outside the width of the printable web 8, so that the printable web 8 can be deflected by the compressed-air jets 35, 36 past this one part 42 without obstruction in the event of web breakage. The at least one compressed-air nozzle 32,34 is or are located on the same web side of the printable web 8, spaced at a distance from the printable web 8, as the other part, e.g., the transmitter 41, which is located closer to the latitudinal center of the web than the corresponding other part, e.g., the receiver 42.

In FIGS. 3 and 4, the one part is the receiver 42 and the other part is the transmitter 41; however, these parts could also be placed in opposite positions relative to one another. The longitudinal web edge strips 22, 24 blown away by the compressed-air jets 35 and 36 are indicated by dashed lines in FIGS. 3 and 4, whereas the printable web 8 is indicated by continuous straight lines in a latitudinal direction, as is the case when they are under tensile stress during normal printing operation.

According to another preferred embodiment of the invention shown in FIG. 4, the pneumatic deflection force of the at least one compressed-air jet 35 or 36, preferably of both compressed-air jets 35 and 36, is set to be sufficiently strong, and the at least one compressed-air jet 35 or 36 is directed at the longitudinal web edge strip 22 or 24 at a sufficient distance from the longitudinal web strip 60 or 62 so that, at a tensile force of the printable web 8 suitable for normal printing operation, the pneumatic deflection force produces a depression 64 or 66 in the printable web 8 extending in the longitudinal direction of the web in the region of the longitudinal web edge strips 22 and 24. As a result of the depressions 64 and 66, the longitudinal web edge strip 22 and 24 are stiffened. This prevents fluttering of the paper edges, thereby improving the operational reliability of the monitoring device.

In this context, it is also possible to arrange the detection axis 44 and therefore the detection beam 43 in such a way that they each intersect the longitudinal web edge strips 22 and 24 in the region of the depression 64 or 66, preferably in the region of the outer half of the depression and, even more preferably in close proximity to the longitudinal web edge 60 or 62. As a result, the longitudinal web edge strip 22 or 24 is already moved out of the detection axis 44 and, therefore, out of the detection beam 43 in response to a minor deflection by the compressed-air jets 35 or 36. Thus, the monitoring device generates a web breakage signal 40 very rapidly when the tensile stress of the printable web 8 suddenly declines in the event of breakage of the printable web.

According to another concept of the invention, which is shown schematically in FIGS. 2,3 and 4, at least two compressed-air nozzles corresponding to the two compressed-air nozzles 32 and 34 are provided for at least one of the two longitudinal web edge strips 22 and 24, preferably for both, from which compressed-air nozzles the compressed-air jet 35 (or 36) of the one compressed-air nozzle 32 (or 34) is directed at the longitudinal web edge strip 22 or 24 at closer proximity to the longitudinal web edge 60 or 62 than the compressed-air jet 36 (or 35) of the other compressed-air nozzle 34 (or 32). The two compressed-air jets 34 and 36 are therefore applied to points on the printable web 8 that are offset relative to one another in the latitudinal direction of the web.

As a result, more rapid deflection of the printable web 8 out of the detection beam 44 is achieved in the event of web breakage.

The various concepts of the invention, especially the web velocity-dependent change in the deflection force of the compressed air acting on at least one longitudinal web strip 22 or 24, the formation of a longitudinal depression 64 or 66 in the printable web 8 in proximity to the edge, and the offsetting, relative to one another, of the points of contact of the two compressed-air jets on at least one longitudinal web edge strip 22 or 24, are measures that can be used independently of one another to improve the operational reliability of the web breakage monitoring device. Operational reliability is further improved by the use of two or more of these concepts.

1. Web breakage monitoring device for web-fed rotary printing presses; containing at least one detection device (26) that is oriented at right angles to the web plane toward at least one longitudinal web edge strip (22, 24) of a printable web (8) for detecting the longitudinal web edge strip (22, 24) of the printable web (8) under tensile stress during normal printing operation and for generating a web breakage signal (40) if the longitudinal web edge strip (22,24) drops out of the detection range of the detection device (26) when the tensile stress of the printable web decreases as a result of web breakage; at least one pneumatic deflection device (30) located in proximity to the detection device (26) that contains at least one compressed-air nozzle (32,34) directed at right angles to the web plane toward the longitudinal web edge strip for generating a permanent pneumatic deflection force acting on the longitudinal web edge strip at right angles to the web plane, surmountable by the tensile force of the printable web during trouble-free operation, by means of which in the event of a loss of tensile stress the longitudinal web edge strip (22,24) can be deflected at right angles to the web plane and thus removed from the detection range of the detection device; characterized by a control device (50) that reacts to a web velocity signal (52) that changes with changing web velocity and as a factor thereof reduces the pneumatic deflection force of the at least one compressed-air nozzle (32, 34) acting on the printable web (8) to a predetermined degree with decreasing web velocity and increases it with increasing web velocity.

2. Web breakage monitoring device according to claim 1, characterized in that the control device (50) is designed to change the pressure of the compressed air that is supplied to the at least one compressed-air nozzle (32,34) so as to reduce the pneumatic deflection force of the compressed air flowing from the at least one nozzle with decreasing web velocity and increasing it with increasing web velocity.

3. Web breakage monitoring device according to at least one of the preceding claims, characterized in that the detection device (26) has a transmitter (41) for transmitting a detection beam (43) and a receiver for receiving the detection beam (43) that are positioned or capable of being positioned on both sides of the web plane so that the detection beam (43) intersects the web plane in the region of the longitudinal web edge strip (22, 24) and is intersected by the longitudinal web edge strip when the printable web is under normal tensile stress for printing operation, whereas in the event of the tensile stress of the printable web falling below a specific minimum value the longitudinal web edge strip is moved out of the detection beam (43) by the pneumatic deflection force of the compressed-air jet of the at least one compressed-air nozzle (32, 34).

4. Web breakage monitoring device according to claim 3, characterized in that the one part, transmitter (41) or receiver (42), is located on one web side and the other part, transmitter (41) or receiver (42), is located on the other web side of the printable web (8), the two parts being offset relative to one another and the detection beam (43) being disposed at an angle relative to the web plane of the printable web (8) corresponding to the offset, and the part that is offset closer to the center of the web being located on the same web side as the at least one compressed-air nozzle (32, 34).

5. Web breakage monitoring device according to at least one of the preceding claims, characterized in that the pneumatic deflection force is set to be sufficiently strong and is directed at the region of the longitudinal web edge strip (22, 24) at right angles to the web plane at a sufficient distance from the longitudinal web edge (60, 62) so that the at a tensile force of the printable web (8) suitable for printing operation pneumatic deflection force produces a depression (64, 66) in the printable web (8) extending in the longitudinal direction of the web in the region of the longitudinal web edge strips (22, 24).

6. Web breakage monitoring device according to claims 4 and 5, characterized in that the transmitter (41) and the receiver (42) are arranged in such a way that the detection beam (43) intersects the printable web (8) in the depression (64, 66), preferably at the deepest point of the depression or the outer half of the depression, when the printable web is under tensile stress suitable for printing operation.

7. Web breakage monitoring device according to at least one of the preceding claims, characterized in that at least two compressed-air nozzles (32, 34) arranged on the same web side of the printable web (8) are provided adjacent to at least one longitudinal web edge strip (22,24), their compressed-air jets (35,36) being directed at two positions on the longitudinal web edge strip (22, 24) that are offset relative to one another in the latitudinal direction of the web, so that the one compressed-air jet (35) contacts the longitudinal web edge strip (22, 24) closer to the edge of the web (60, 62) than the other compressed-air jet (36).

8. Web breakage monitoring device according to at least one of the preceding claims, characterized in that two assemblies are provided, each of which includes a detection device (26) and a pneumatic deflection device (30) according to at least one of the preceding claims, the one assembly being provided for the one longitudinal web edge strip (22, 24) and the other assembly for the other longitudinal web edge strip (22, 24) of the printable web (8).
